(19) United States
(12) Patent Application Publication
(10) Pub. No.: US 2019/0100141 A1
(43) Pub. Date: Apr. 4, 2019

(54) Ascertainment of Vehicle Environment Data

(71) Applicant: Bayerische Motoren Werke Aktiengesellschaft, Muenchen (DE)

(72) Inventor: Alexander AUGST, Munich (DE)

(21) Appl. No.: 16/193,981

(22) Filed: Nov. 16, 2018

Related U.S. Application Data
(63) Continuation of application No. PCT/EP2017/059878, filed on Apr. 26, 2017.

(30) Foreign Application Priority Data
May 17, 2016 (DE) 10 2016 208 369.4

(51) Int. Cl. B60R 1/00; G06K 9/00

(52) U.S. Cl. CPC B60R 1/00; G06K 9/00791; B60Q 9/00; B60R 2300/8093; B60R 2300/304

(57) ABSTRACT

A method for establishing data representing an environment below a vehicle include capturing surroundings data representing at least a part of the environment of the vehicle, assigning position information items to the surroundings data, determining a position parameter of the vehicle, and determining vehicle ground data from the surroundings data, wherein the position information items correspond to the position parameter of the vehicle such that the vehicle ground data represent a region of the environment of the vehicle above which the vehicle is currently situated. The vehicle ground data is then output on a display apparatus of the vehicle.

### CROSS REFERENCE TO RELATED APPLICATIONS

This application is a continuation of PCT International Application No. PCT/EP2017/059878, filed Apr. 26, 2017, which claims priority under 35 U.S.C. § 119 from German Patent Application No. 10 2016 208 369.4, filed May 17, 2016, the entire disclosures of which are herein expressly incorporated by reference.

### BACKGROUND AND SUMMARY OF THE INVENTION

The present invention relates to a method for establishing data representing a part of the environment below a vehicle. In particular, the intention is to establish surroundings data representing a region of the environment of the vehicle currently situated below the vehicle.

The prior art has disclosed numerous camera systems for vehicles. In particular, these comprise a reversing camera or laterally attached cameras. Different images can be produced from the raw data of the cameras, for example view of the rear region of the vehicle or a virtual view from a bird's eye view.

The prior art has likewise disclosed a camera capturing a terrain below the vehicle. However, such cameras are disadvantageous in that these are not operational or only have restricted operability during the operation of the vehicle on account of dirtying.

Apart from the problem with dirtying, a camera below the vehicle has a very inexpedient capture angle and, consequently, a very inexpedient capture perspective for a three-dimensional form of the terrain. For these reasons, an image of such a camera is hardly evaluable.

It is an object of the present invention to provide a method for establishing data representing an environment of a vehicle which, with a simple and cost-effective application, facilitates an improved establishment of surroundings data of a vehicle, in particular surroundings data representing regions below the vehicle.

Consequently, the object is achieved by a method for presenting surroundings data of a vehicle, including the steps set forth below. Initially, surroundings data are captured. The surroundings data represent at least a part of the environment of the vehicle. Advantageously, surroundings data are captured by means of at least one surroundings sensor system of the vehicle. At least a certain part of the environment is buffer storable, at least in portions, by way of the surroundings sensor system of the vehicle. Here, the surroundings data may comprise sequential measurements or a continuous data stream.

Subsequently, position information items are assigned to the surroundings data. Preferably, position values are assigned portion-by-portion to the surroundings data. Particularly preferably, the positions of certain pixels from the surroundings data are assigned to certain position information items. Here, a position information item can be assigned to each pixel or to pixel groups from the surroundings data or else only certain pixels can be provided with position information items such that a position information item can be established for each other pixel by means of an extrapolation. By way of example, it is possible to determine pixel groups of 10×10 pixels to 20×30 pixels, which are each assigned to one position value.

As a further step, there is determining a current position of the vehicle.

Here, the position parameter is a position-dependent variable which changes, in particular, in the case of local movements of the vehicle in a manner corresponding to the change in position, for example in the case of forward travel, backward travel, lateral movement or rotation of the vehicle. The position parameter may represent an absolute position, in particular a global position, and/or a relative position, in particular local position, of the vehicle. In particular, the position parameter can relate to the position of one or more certain parts of the vehicle in relation to its environment.

The position parameter may relate to the current position of the vehicle and/or to the position of the vehicle in the near future, for example in 0.3-30 seconds.

Preferably, the position parameter represents a vehicle position in relation to a certain part of the environment. By way of example, a position parameter can be expressed as a vector, a composition of vectors and/or in a coordinate system, in particular a local coordinate system, for example in a cylindrical coordinate system. Preferably, the position parameter comprises one or more angle values, in particular relative angle values.

Furthermore, vehicle ground data are determined from the surroundings data. Using the current position of the vehicle, it is possible to determine the vehicle ground data from the surroundings data in such a way that the position information items of the surroundings data correspond to the current position of the vehicle, in particular within a predefined tolerance value. The tolerance value preferably ensures that the vehicle ground data represent at least a region of the environment of the vehicle over which the vehicle is currently situated. Here, the vehicle ground data may be an amalgamation of a plurality of such data representing a region from the environment of the vehicle which is at least partly covered by the vehicle.

Finally, there is a provision of the vehicle ground data and/or output of the vehicle ground data, in particular for display purposes on a display apparatus. Further, the established vehicle ground data may be provided for further processing in the vehicle, for example for a vehicle function comprising an interpretation of the situation. Further, the established vehicle ground data can be provided to a computing unit outside of the vehicle, in particular to a backend or to a mobile application appliance of the user. In particular, a mobile user appliance comprises a display apparatus for outputting a presentation dependent on the provided vehicle ground data. By way of example, a mobile user appliance can be a smartphone, a tablet, so-called smartglasses or expedient developments of such apparatuses.

One or more described steps of the method are preferably carried out cyclically, in particular several times per second, wherein data representing an image sequence representing the vehicle ground data are provided and/or output.

Particularly preferably, the provision of the (respective) vehicle ground data and/or the output of the vehicle ground data is effected depending on the current position information item of the vehicle. By way of example, the output can be effected as an image sequence on a display apparatus depending on the change in the position information item.

Particularly preferably, the method can be applied, in particular, to parking processes, maneuvering processes or travel on uneven terrain parts (so-called off-road region) with at least one wheel. Preferably, uneven terrain parts can also be part of a soft shoulder.

In an advantageous embodiment of the invention, a movement parameter is moreover established. The movement parameter represents a movement of the vehicle. Here, provision is made, in particular, for the movement parameter to comprise a resultant movement of the vehicle, in particular a plurality of successive movements of the vehicle. Advantageously, the movement parameters can be recorded odometric data. In particular, this comprises a history of the plurality of maneuvering movements of the vehicle. The recorded odometric data are advantageously established from wheel sensors and/or steering wheel sensors. In another alternative, the movement parameters are obtained from the surroundings sensors. This is brought about, in particular, by virtue of a 3D camera for capturing surroundings data being used as a surroundings sensor, said 3D camera also supplying data about the movement of the 3D camera, and hence of the vehicle, in addition to the spatial representation of the surroundings. Moreover, provision is advantageously made for a predicted future movement of the vehicle being captured as a movement parameter. In this way, movement parameters are available not only from the past and the present but likewise as predicted movements in the future. In particular, the movement parameter can relate to a history of one or more complex movements, e.g., maneuvering movements, of the vehicle. The movement parameters or the underlying odometric data are advantageously established from wheel sensors and/or steering wheel sensors and/or the steering angle sensors. When establishing the movement parameter, it is possible to take account of a mathematical vehicle model, e.g., a specifically developed Ackermann model. Here, it is possible to take account of at least one rotation of the vehicle about at least one vertical axis or two vertical axes (particularly in the case of vehicles comprising a rear-wheel steering) and/or an inclination, roll. As an alternative or in addition thereto, establishing the movement parameter may comprise reading movement data from a data interface, for example provided for this purpose and/or for another purpose.

Here, the movement parameter is a variable that depends on the movement of the vehicle. In particular, the movement parameter can relate to the movement of one or more certain parts of the vehicle in relation to its environment. Here, the movement parameter can be an absolute movement of the vehicle and/or a relative movement of the vehicle, in particular a local movement of the vehicle. Preferably, the movement parameter represents a vehicle movement in relation to a certain part of the environment. By way of example, a movement parameter can be expressed as a vector, a composition of the vectors and/or in a coordinate system, in particular a local coordinate system, for example in a cylindrical coordinate system. Particularly preferably, the movement parameter represents the movement of at least two wheels of the vehicle, wherein the movement of the wheels can be captured, in particular, by means of wheel sensors.

Furthermore, provision is preferably made for surroundings data to be determined for a first region of the surroundings from the captured surroundings data after capturing the surroundings data and capturing the movement data. Here, provision is made for the first region of the surroundings to represent a portion of the environment of the vehicle which, on account of the movement data, will lie under the vehicle in the future with a predefined probability value. To this end, the movement data are preferably extrapolated, as a result of which regions are extractable from the surroundings data; a value for the probability with which the vehicle will drive over this region can be assigned to said regions in each case. Should the probability value exceed a defined limit value, the corresponding region is assigned to the first region of the surroundings. Consequently those regions of the environment over which the vehicle will drive in the future with at least the predetermined probability value are known. The vehicle ground data is subsequently determined from the drive-over data. The surroundings data for the first region of the surroundings is also referred to as drive-over data below.

Here, the method may comprise establishing a probability value representing the probability that a certain part of the surroundings will be covered by the vehicle in the future. As an alternative or in addition thereto, it is possible to establish a variable which allows the deduction that a certain region of the environment will be covered in the future by the vehicle with a probability that exceeds a certain value.

Here, the method may comprise that, depending on a movement parameter and/or a position parameter of the vehicle, there is establishment that a certain region of the environment will be covered in the future by the vehicle with a probability that exceeds a certain value.

The position of the vehicle contour may be decisive for coverage of a part of the environment by the vehicle. In particular, the coverage relates to a part of the environment that is delimited by the contour of the vehicle or by a projection of the vehicle contour onto the terrain.

Determining the drive-over data advantageously reduces the complexity of carrying out the method. Thus, it is only necessary to buffer store such data, namely the drive-over data, which represent a portion of the environment of the vehicle over which the vehicle will be situated with a predefined probability value. Other data, which do not represent such regions, i.e., the first region of the surroundings in particular, need not be buffer stored. Consequently, the outlay for carrying out the method is reduced. The vehicle ground data provides data that represent a region of the environment of the vehicle that currently lies below the vehicle. Consequently, no ground camera of the vehicle is necessary in order to be able to visualize the region below the vehicle. Therefore, it is possible to display to a driver of the vehicle a high-quality image of the environment below their vehicle, which simplifies parking processes or travel on uneven paths, in particular.

In a preferred embodiment, the method includes the steps set forth below. Periphery data are additionally determined, the periphery data representing a portion of the environment currently not lying under the vehicle. Consequently, the periphery data are such data that represent an environment and/or obstacles next to, in front of or behind the vehicle. Preferably, the periphery data are obtained in real time and consequently need not be buffer stored. The periphery data are preferably data that were or are captured by means of an environment sensor system of the vehicle. Advantageously, the environment sensor system is an imaging sensor system or a distance sensor system. Alternatively, the periphery data can also be extracted from the surroundings data. After determining the periphery data, the periphery data and the vehicle ground data are advantageously merged. Finally, the merged periphery data and vehicle ground data are output. If the merged data are displayed on a display apparatus, a comprehensive image of the environment of the vehicle is provided to the driver of the vehicle. In addition to representation of the region below the vehicle, this image also comprises a presentation of captured obstacles next to, in front of and behind the vehicle. Should the periphery data have been captured by means of imaging sensors, it is possible to display a complete image of the surroundings to the driver of the vehicle, as if the vehicle were not present.

Particularly advantageously, the merging of the periphery data and the vehicle ground data comprises temporal and/or spatial merging. Here, provision is particularly advantageously made for the merging to comprise, in particular, determining a geometric relation between periphery data and vehicle ground data and geometrically transforming the periphery data and/or the vehicle ground data on the basis of the geometric relation. Temporal merging comprises, in particular, a comparison of capture times of the periphery data and the surroundings data, from which the vehicle ground data were determined. On the basis of the capture time, it is consequently possible to determine periphery data and surroundings data that are synchronized in time. The geometric relation is advantageously established depending on the movement data. Thus, it should be noted, in particular, that surroundings data and periphery data can be captured at different vehicle moving speeds. For this reason, the periphery data and the vehicle ground data, which were determined from the surroundings data, must be geometrically transformed on the basis of the geometric relation in order to spatially synchronize the periphery data and the vehicle ground data.

Here, the geometric relation is preferably a mapping function between the 3D data from the environment and data, 2D ground data or corresponding 2D imaging data. Further, the geometric relation can be a mapping function of 2D data to 2D data, 3D data into 3D data or 2D data into 3D data.

Here, the geometric relation may supply a different result depending on a local position of a region. That is to say, the mapping function can map a different geometric relation depending on a position of the mapped terrain region. This geometric relation or the mapping function can represent a prescription for changing the pixel position of a part of the surroundings data for the purposes of producing a part of the ground data.

By way of example, the method includes reading selected parts of the stored surroundings data from a memory of the vehicle, wherein the parts of the surroundings data to be read are chosen depending on the established movement data, applying a mapping function, wherein the ground data are established in relation to a certain vehicle position, and providing the ground data (in relation to a certain vehicle position) and/or outputting the ground data on a display apparatus when the respective vehicle position is reached or imminent.

The temporal merging comprises, in particular, comparing capture times of the periphery data and the surroundings data, from which the ground data have been determined. On the basis of the capture time, it is consequently possible to determine periphery data and surroundings data that are temporally synchronized.

As an alternative or in addition thereto, the method may comprise a step for establishing and/or capturing a temporal mapping function which represents establishing the pixel values of the ground data for a certain frame of the display from one or more pixel values of the surroundings data from one or more further time intervals.

In an alternative, merging the periphery data and the vehicle ground data particularly advantageously comprises recognizing and/or identifying and/or assigning textures and/or immovable objects in the periphery data and/or vehicle ground data. Subsequently, the periphery data and vehicle ground data are homogenized on the basis of the textures and/or immovable objects. Advantageously, a relative speed of the textures and/or immovable objects is established to this end in the periphery data and the vehicle ground data. Since such a relative speed must be identical both in the periphery data and in the vehicle ground data, it is possible to derive a rule for homogenizing the periphery data and the vehicle ground data. In particular, the periphery data and the vehicle ground data should be homogenized in such a way that textures and/or immovable objects are always present at the same location and move with the same relative speed in both the periphery data and the vehicle ground data.

In a further preferred embodiment of the invention, the vehicle ground data are output together with wheel information items, in particular with the current alignment and/or a current position of the wheel of the vehicle and/or a position of the wheel of the vehicle that is predicted, in particular on the basis of the movement data. In particular, the at least one wheel is a front wheel or a rear wheel of the vehicle. By way of the position and/or alignment of the presented wheel, a trajectory of the wheel, in particular, is represented, said trajectory advantageously being predicted on the basis of the movement data by way of extrapolation. In this way, there is visualization of, in particular, a relation between the wheels of their vehicle and peculiarities in the environment of the vehicle, such as parking lines and/or curbs and/or potholes, in particular, for the driver of the vehicle.

Advantageously, there is a display of the vehicle ground data and/or the merged vehicle ground data and periphery data on a display apparatus when a predefined event occurs. In particular, the predefined event is traveling on an uneven path and/or approaching an obstacle and/or exceeding predefined vertical-dynamic influences on the vehicle. In the case of the predefined event, the driver of the vehicle considers it helpful to obtain additional information items in respect of the surroundings below the vehicle. Consequently, the vehicle ground data or merged vehicle ground data and periphery data are only displayed if these also are able to supply a helpful information item. Without the predefined event, the display of the vehicle ground data or the merged vehicle ground data and periphery data is a redundant information item, which provides the driver of the vehicle with no additional value and which requires many resources at the same time.

Particularly preferably, provision is made for a geometric transformation of the images representing the vehicle ground data, in particular a virtual perspective relation thereof, to be controlled, in particular depending on: the perspective ratio with which another part of the presentation is represented and/or an identified danger zone in relation to a part of the vehicle, in particular in relation to at least one wheel of the vehicle.

By way of example, images of the external cameras are converted or translated into different perspectives according to the prior art. Also, a model-like image of the own vehicle (in a matching perspective) is inserted into the image (according to the same invention). In the new methods it is also possible to subject the images relating to the first terrain part (from the near past) to an analogous procedure, “belatedly” as it were.

In the method, the perspective relation can preferably be adapted depending on the position in the surroundings and/or on the vehicle which is affected by the ascertained danger. Here, it is possible to seek or achieve an improved (early) perception of a potential danger by the driver by adapting the corresponding perspective relationship in one or more steps.

Particularly preferably, there is a step-by-step, in particular continuous adaptation of the perspective ratio. In the process, the driver can better comprehend the change.

In the case of an automatic recognition of danger in relation to a wheel of the vehicle, for example a wheel which is dangerously close or at a dangerously sharp angle in relation to the curb, the perspective of the images from the first terrain part or else the perspective of further parts of the presentation can be varied, wherein, for example, a perspective for an improved avoidance of danger is found.

Likewise, provision is particularly preferably made for a geometric transformation, in particular a virtual perspective ratio, of the images of the vehicle ground data and/or of the images of the periphery data to be adapted at least in a boundary region of the two display parts, in particular in such a way that the boundary region of the display of the vehicle ground data and of the display the periphery data represents a transitionless or visually comprehensible continuation of the textures of the surroundings.

Here, the geometric transformation may comprise, for example, scaling, stretching, expanding, deforming, e.g. in trapezoidal manner, stitching and changing the virtual perspective.

In particular, the environmental image, representing a region of the environment occupied by the vehicle and a region of the environment outside of the region occupied by the vehicle within a presentation or display apparatus is displayed with a “compatible” scaling and/or perspective ratio.

Furthermore, provision is advantageously made for a part of the environment of the vehicle situated outside the region occupied by the vehicle in the vicinity of the contour of the vehicle to be produced from the vehicle ground data, wherein there is an adaptation of geometric and/or perspective parameters of the vehicle ground data and/or of the periphery data such that the textures of the vehicle ground data are displayed in a manner fitting to the textures of the periphery data. Here, a substantially “texture-real” transition should be created.

Likewise, provision is preferably made for the presentation also to comprise at least one graphic representing, at least symbolically, the dimensions of the vehicle, in particular a contour of the vehicle, wherein the graphic preferably represents the boundary between the parts of the display relating to the vehicle ground data and the parts of the displays relating to the periphery data. Consequently, the driver can clearly distinguish between which obstacles are (should be, may be) below the vehicle underbody and which are not. Here, attention may also be drawn to the fact that the presentation of the vehicle ground data comprises a less reliable information item in comparison with the presentation of the periphery data (since, as a rule, it is outdated by a few seconds).

The surroundings data are advantageously generated by means of at least one camera and/or by means of at least one sensor for scanning the environment of the vehicle. The at least one camera is advantageously a 3D camera system. In particular, provision is made for the surroundings data, combined from the data of the camera and the at least one sensor for scanning the surroundings, to be put together. The at least one sensor is advantageously a distance sensor, in particular an infrared sensor, a laser sensor or an ultrasound sensor.

When capturing the surroundings data, provision is advantageously made for continuous capture to be effected. In an alternative embodiment, capture need not necessarily be effected continuously. Thus, it is possible to capture a plurality of surroundings data representing individual regions from the environment. Here, provision is made for the plurality of surroundings data to be merged according to their spatial position information items. Should the plurality of surroundings data represent overlapping regions, i.e., should the surroundings data at least partly represent the same area of the environment of the vehicle, provision is advantageously made for the most recent data to be stored at all times, while the older data are deleted.

The position information items can be a position information item relative to the vehicle, in particular. Here, the position information item advantageously comprises at least two distance information items or at least one distance information item and at least one angle information item. As a result of these information items, each point in the environment of the vehicle is uniquely describable.

Particularly preferably, positions of the vehicle predicted for the near future are also taken into account. The predicted positions of the vehicle can be established advantageously on the basis of the movement parameter. In this way, it is possible to compensate a delayed output of a presentation of the vehicle ground data, in particular due to technological constraints, on a display apparatus of the vehicle.

By using the position information items, a very accurate assignment of the surroundings data to the vehicle is facilitated. Consequently, it is possible to very accurately display a region below the vehicle. Furthermore, provision is particularly advantageously made for the movement parameter to be extracted from the established positions of the vehicle. Consequently, no additional sensors are required for establishing the movement data of the vehicle.

Moreover, provision is preferably made for the movement parameter to be a resultant movement of the vehicle, in particular of a plurality of successive movements of the vehicle. By way of example, the movement parameter can be established from the recorded odometric data, for example a history of a plurality of maneuvering movements of the vehicle, for example, during the maneuvering process made up of a plurality of maneuvering passages. That is to say, the current odometric data and the odometric data that have been recorded in the recent past can be taken into account in the method. Here, the odometric data can be established from wheel sensors, steering wheel sensors, for example. Movement data can also be established depending on the operating processes of the vehicle (steering wheel sensor forward, backward). Particularly preferably, movement parameters can also be effected depending on the capture of the vehicle environment by sensors, for example also depending on the data of the same camera. Here, a relative movement of the vehicle can be established depending on a movement of the objects or textures in the sensor data. Particularly preferably, movement data predicted for the near future are also taken into account. Consequently, it is possible to compensate the slightly delayed (due to technological constraints) output of the presentation on the display apparatus of the vehicle. Additionally, it is possible to establish the selection of the vehicle ground data depending on the predicted movement parameter (e.g., for the next seconds). Additionally, it is possible to establish movement parameters depending on, for example, (precisely determined) coordinates or changes in coordinates and/or an alignment of the vehicle or a change in the alignment of the vehicle.

Furthermore, provision is preferably made for a combination of an environment image, representing a first part of the environment, which is currently occupied by the vehicle, and a second part of the environment, which is currently outside of the region covered by the vehicle, to be output, preferably within a presentation and/or display apparatus. By way of example, the driver (as a final result) can directly see a plurality of parts of a dangerous curb through the windshield, by way of a current image of a side camera and by way of the adapted data for the “underbody image” produced during the method. Result: much better orientation, objective and subjective safety, better parking.

Advantageously, provision is made for vehicle ground data to be established from images of a camera and/or of a sensor for recognizing or measuring objects or the terrain relief. Particularly preferably, the first data can comprise at least camera images AND a further information item, in particular an interpreted information item, in relation to objects or a terrain relief that was captured by sensors. The method can be applied together or separately thereon. From this, a presentation may result which offers the driver different or complementary information items.

Moreover, the invention relates to a computer program product. The computer program product comprises a machine-readable code with instructions which, when carried out on a programmable processor of a controller, cause the processor to carry out the steps of a method as described above. In particular, the controller is usable in a vehicle.

Moreover, the invention relates to an apparatus for a vehicle, wherein the apparatus comprises at least one controller that is embodied, in particular, to run the above-described computer program product. Likewise, the apparatus is advantageously configured to carry out the above-described method or part of the method.

The apparatus and the computer program product have the same or analogous advantages as the described method.

Finally, the invention relates to a vehicle which comprises an apparatus as described above or which is configured to operate such an apparatus.

The vehicle within the scope of this description is, in particular, a motor vehicle (automobile, truck, transporter, a so-called “semitrailer tractor”) or a vehicle trailer (mobile home, goods trailer, horse box, yacht trailer). A plurality of advantages which are explicitly and implicitly described in this document and further advantages that are easily comprehensible by a person skilled in the art arise therefrom. Moreover, the vehicle can also be a watercraft, submarine or aircraft or spacecraft, wherein the method is applied analogously.

Further details, features and advantages of the invention emerge from the following description and the figures. In the figures:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first schematic image of a vehicle according to an exemplary embodiment of the invention for carrying out the method according to an exemplary embodiment of the invention.

FIG. 2 shows a second schematic image of the vehicle according to the exemplary embodiment of the invention when carrying out the method according to the exemplary embodiment of the invention.

### DETAILED DESCRIPTION OF THE DRAWINGS

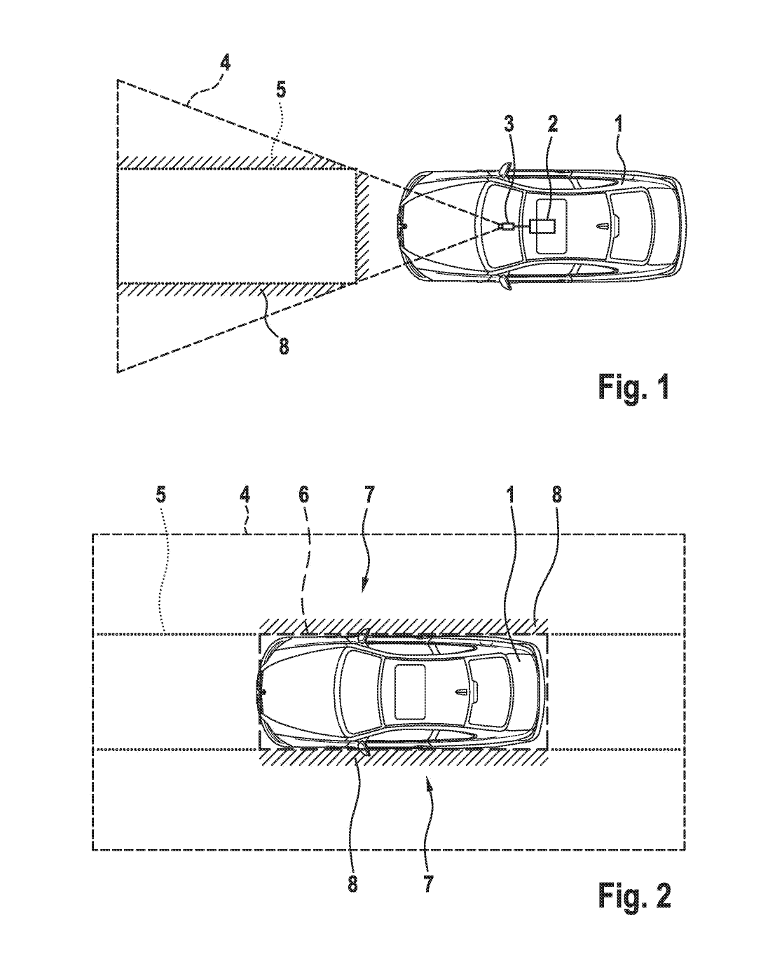

FIG. 1 shows a vehicle 1 according to an exemplary embodiment of the invention. The vehicle 1 comprises an apparatus 2 comprising a controller. The method according to an exemplary embodiment of the invention is implementable by means of the apparatus 2. To this end, the apparatus 2, the controller in this example, is connected to a camera 3 such that data are interchangeable between the camera 3 and the controller. Likewise, the apparatus 2 is connected to wheel sensors (not shown) of the vehicle 1. This allows the controller to capture a plurality of movement parameters, which are referred to in an overarching manner as movement data in this example, of the vehicle 1, which are established by the wheel sensors. Moreover, the apparatus 2 is able to capture surroundings data 4 of the vehicle 1, which is carried out by means of the camera 3.

In particular, the camera 3 can be an infrared camera, a time-of-flight camera or an imaging camera. As an alternative to the camera 3, use can be made, in particular, of a laser scanner, an ultrasound sensor system or a radar sensor system. Here, the surroundings data 4 can be generated either by the camera 3 on its own or by combining data of the camera 3 with data of further sensors, as specified above. Should the surroundings data be merged from data of a plurality of sensors, this is dependent on, in particular, a degree of correspondence between the terrain parts represented by the respective data, the data quality of the data portions, the perspective of capture of the respective environment by the corresponding sensor and the age of the respective data.

In the shown exemplary embodiment, the surroundings data 4 are captured by the camera 3. Drive-over data are determined from the surroundings data 4. The drive-over data correspond to the surroundings data for a first region of the surroundings 5 from the environment of the vehicle 1, wherein the vehicle 1 will drive over the first region of the surroundings 5 in the future with a predefined probability on account of the movement data. In the exemplary embodiment shown in FIG. 1, the vehicle is traveling in a straight line, and so the assumption can be made that regions in front of the vehicle 1 will lie under the vehicle 1 in the future. In this way, the drive-over data are determined from the surroundings data 4. The remaining surroundings data 4 need not be buffer stored and can therefore be deleted. Advantageously, it is only the drive-over data that are buffer stored in the controller 2. In an alternative exemplary embodiment, no drive-over data are determined and the surroundings data 4 are buffer stored instead. Determining vehicle ground data 6, as described below, is then carried out on the basis of the surroundings data 4.

Position information items are assigned to the drive-over data. The position information items are, in particular, such information items that are specified relative to the vehicle or relative to a reference point in the environment. Here, a position, relative to the vehicle 1, of the region of the environment represented by the respective pixel is assigned to each pixel position within an image of the camera 3.

Moreover, the controller 2 is configured to establish a current position of the vehicle 1. The movement data are extracted from the established positions of the vehicle. Consequently, no additional sensors are required for establishing the movement data of the vehicle. In one alternative, provision is particularly advantageously made for the movement data to be recorded odometric data. In another exemplary embodiment, the movement data are advantageously established depending on operating processes of the vehicle 1 by a driver. To this end, the movement data are advantageously established on the basis of a steering wheel sensor in a movement direction of the vehicle. In another alternative, the movement data are established by capturing the environment of the vehicle 1 by sensors. Consequently, the movement data can be established in a manner analogous to the surroundings data, advantageously from the data of the camera 3.

Particularly preferably, movement data predicted for the near future are also taken into account. Consequently, it is possible to compensate a delayed output, due to technical constraints, of the determined vehicle ground data.

Finally, provision is preferably made for the movement data to be established depending on precisely determined coordinates or changes in the coordinates and/or an alignment of the vehicle or a change in the alignment of the vehicle.

FIG. 2 shows how current vehicle ground data 6 of the vehicle 1 are established. To this end, vehicle ground data 6 are determined from the drive-over data, wherein this is effected on the basis of the position information items and the current position of the vehicle 1. Consequently, it is possible to determine vehicle ground data from the drive-over data, i.e., from the surroundings data for the first region of the surroundings, in such a way that the position information items of the first region of the surroundings 5 correspond to the current position of the vehicle 1 within a predefined tolerance value. In particular, the tolerance value represents a dimension of the vehicle 1, and so the vehicle ground data 6 represent at least a region of the environment of the vehicle 1 above which the vehicle 1 is currently situated. Consequently, the vehicle ground data 1 are a combination of all such data representing a region from the environment of the vehicle 1 which is completely covered by the vehicle 1.

The vehicle ground data 6 are advantageously output to a display apparatus of the vehicle 1 so that the environment underneath their vehicle can be displayed to the driver. There is, in particular, a suitable geometric transformation in this case in order to show the driver the vehicle ground data 6 from a suitable perspective, in particular from a bird's eye view.

A very accurate assignment of the surroundings data to the vehicle is facilitated by using the position information items. Consequently, it is possible to very accurately display a region below the vehicle.

If the image of the camera 3 is used to display the vehicle ground data 6, this image is converted, in particular, to a suitable perspective. Moreover, provision is preferably made for a model-like image of the vehicle 1 to be inserted into the display in a presentation matching the perspective. Converting the perspective is brought about, preferably, by geometric transformations such as, in particular, scaling, stretching, expanding, deforming, e.g. in trapezoidal manner, stitching and changing the virtual perspective.

The vehicle ground data 6 are advantageously only displayed once a predefined event occurs. The predefined event is, in particular, driving on an uneven path, approaching an obstacle or curved terrain, exceeding predefined vertical-dynamic influences on the vehicle or recognizing an operating action of the driver corresponding to a predefined operating pattern. Such an operating pattern can be, in particular, the preparation of a parking maneuver, a maneuvering maneuver or a turning maneuver. Only if the predefined event occurs are the vehicle ground data 6 presented on the display apparatus, and so an image of the environment below their vehicle is only provided to the driver of the vehicle when these are required by the latter. This avoids superfluous information items that would be considered bothersome by the driver. At the same time, the information being available when they are a valuable aid to the driver is ensured.

Preferably, a tire position and/or an alignment of the tires of the vehicle 1 is moreover presented on the display apparatus. Here, front wheels and/or rear wheels can be selectively represented. By presenting the wheels of the vehicle 1, the driver of the vehicle 1 is able to estimate the risk of a collision between wheels and obstacles in the environment. This is particularly advantageous during a parking process at a curb. Moreover, provision is particularly advantageously made for a change of perspective on the display in the case of an imminent collision between tire and an obstacle in order to better display the imminent collision to the driver.

Preferably, the periphery data 7 of the vehicle 1 are captured in addition to the surroundings data 4. Here, the periphery data 7 can be captured by means of the camera 3. Likewise, the periphery data 7 can be advantageously obtained from the surroundings data 4. The periphery data 7 represent a region of the environment of the vehicle 1 that currently does not lie below the vehicle 1. Particularly preferably, the periphery data are captured in real time such that these always represent regions that are currently lying in front of and/or next to and/or behind the vehicle 1. Here, the periphery data 7 can be captured using the same and/or different sensors than the surroundings data 4.

Preferably, the periphery data 7 and the vehicle ground data 6 obtained from the surroundings data 4 are merged. These merged data are presented, in particular, to the driver of the vehicle 1 on the display apparatus. As an alternative or in addition thereto, the merged data can be provided at a mobile user appliance (configured to this end) of the user and can be output (displayed) at the display or output apparatus (not illustrated here) of the mobile user appliance. Further, the merged data can be provided for a vehicle function which comprises an interpretation of the situation, for example. Consequently, the driver has available a comprehensive image of the environment, said image visualizing regions next to the vehicle 1 in addition to regions below the vehicle 1.

A geometric relation, in particular, between the periphery data 7 and the vehicle ground data 6 is determined to merge the vehicle ground data 6 to the periphery data 7. In particular, a geometric transformation of the vehicle ground data 6 and periphery data 7 is carried out on the basis of this geometric relation.

Preferably, the merged vehicle ground data 6 and periphery data 7 are output in a presentation. Consequently, in particular, a driver of the vehicle 1 can see a curb that is dangerous to the vehicle in different ways in a plurality of portions. Thus, the driver of the vehicle 1 sees the curb directly through the windshield in a first way. Should a side camera of the vehicle 1 be present, the curb is visible in a second way by a current image of the side camera. Moreover, the curb is presentable in a third way by the merged vehicle ground data 6 and periphery data 7. Consequently, improved orientation and consequently improved objective and subjective safety emerges for the driver of the vehicle 1. This facilitates improved parking of the vehicle 1 in a parking space without an imminent risk of a collision with a curb.

Should there be a display in which the combined vehicle ground data 6 and periphery data 7 are shown, a contour of the vehicle 1 is advantageously likewise presented. Consequently, the driver of the vehicle 1 can clearly distinguish which presented obstacles lie under the vehicle underbody and which do not. It is likewise possible to accentuate, advantageously by a faded presentation, in the display that the information items from the vehicle ground data 6 are less reliable as these information items originate from data that have not been recorded in real time. Instead, the vehicle ground data 6 are surroundings data 4, which were captured as the regions of the environment represented by the surroundings data which were situated in front of and/or next to and/or behind the vehicle 1 and were classified as relevant in the future on account of the movement data.

Furthermore, provision is preferably made for edge regions 8 around the drive-over data and/or vehicle ground data 6 to be determined from the surroundings data 4, said edge regions advantageously overlapping with the periphery data 7. Here, provision is made for the edge data 8 to be superposed on the periphery data 7 in such a way during the merging of vehicle ground data 6 and periphery data 7 that there can be a uniform display. In this way, the edge data 8 serve as a transition zone between the vehicle ground data 6 and the periphery data 7. Consequently, harmonizing a transition between the display of the vehicle ground data 6 and the display of the periphery data 7 is facilitated, with the impression of a homogeneous image arising for the driver of the vehicle 1.

Preferably, the surroundings data 4 of a plurality of sensors are captured simultaneously. In the exemplary embodiment shown in FIG. 1, the surroundings data 4 are captured by the camera 3. Advantageously, provision is made for the surroundings data 4 to be additionally captured by distance sensors (not shown) of the vehicle 1. Consequently, individual objects from the environment of the vehicle can be both presented graphically and measured spatially. Consequently, complementary information items can be presented to the driver of the vehicle 1.

Consequently, the driver of the vehicle 1 has an orientation aid available, which represents an aid for operating the vehicle 1, in particular when maneuvering the vehicle 1 and when driving on uneven roads.

Presenting the region below the vehicle 1 allows the driver to identify and avoid imminent collisions of the vehicle 1 with an obstacle in an improved fashion. Consequently, both the objective and the subjective safety of the vehicle 1 is increased. At the same time, the method can be carried out very cost-effectively since only a small part of the captured surroundings data, namely the drive-over data, has to be stored for presenting the region below the vehicle.

Further aspects of the invention are described below:

A video image relating to the region below your vehicle which, in terms of quality, looks like a camera image is shown to you as a driver. To be precise, it is shown as if there is a window to the underbody. Then, you are able to see “through the underbody” in certain traffic situations like in a glass-bottom boat. The virtual perspective of the video image can then be selected or set by the user in such a way that this suggests a “transparent vehicle”, for example as if the vehicle were not here or transparent and the observer would see the terrain region in perpendicular fashion or at a convenient (desired) angle from 1-3 meters height.

Additionally, the resultant presentation visible to the driver or user can be automatically integrated into a three-dimensional, so-called top view or surround view or into other driver assistance systems. The method can also be a basis for presenting augmented graphics into the underbody image. Particularly preferably, the driver is shown the current position and/or alignment of their own tires within the image. These are augmented or integrated into the presentation (into the virtual video) at the corresponding points within the invention. Here, the tires can be presented at least partly in a partly transparent (partly see-through) manner or as contours such that these, where possible, do not substantially cover any useful information item of the presentation.

Further aspects A1 to A10 of suitable vehicle functions are described separately. Moreover, these are freely combinable in an analogous manner with all above-described features.

A1. A method for presenting a terrain region under a vehicle to the driver of a vehicle, wherein:
the first data relating to a first part of the presentation are produced from a first terrain part which will be under the vehicle in the near future with a certain probability;
there is an assignment of the first data relating to certain parts of the presentation to a position information item in the environment of the vehicle,
there is an output of a presentation of the data relating to a first terrain part on a display apparatus depending on the relative position and/or movement of the vehicle in relation to one or more assigned position information items.

The data of the environment sensor system (e.g., front sensor system, e.g., camera) of the vehicle for a certain part of the environment are initially assigned, for example portion-by-portion, to a position information item and buffer stored (together with the corresponding position information items).

In this case, the data relating to the first part of the presentation preferably can be camera images or an already completely combined image of the surroundings, which is produced in a manner known per se (with the cameras in the currently known arrangement on the vehicle). In this method, this is linked to the position information item, i.e., assigned to certain regions of the terrain in the environment of the vehicle.

When these terrain regions are driven on, there is a (suitable) reassignment such that parts of the environment of the track, which go under the vehicle, are reproduced on a display apparatus in such a way that these have a “correct” position and movement relative to the vehicle, in such a way as if these were arriving directly from the camera. That is to say, the first data can be mapped (continued, extended) onto the region that is situated (at least partly) below the vehicle depending on the position of the vehicle.

In particular, the first data can be assigned portion-by-portion to the position values (in the second step of the method). Particularly preferably, the positions of certain pixels in the image are assigned to certain position values (relative to the vehicle). The positions of the pixels for values lying therebetween can be established by means of an interpolation (in the third step of the method).

Here, the first data can be produced, in particular combined, from data of different vehicle sensors (e.g., front camera of the vehicle, lateral mirror cameras, etc.).

In this way, the first data can be merged from data of different sensors, depending on: a degree of correspondence between the terrain parts represented in the respective data and the expected future positions or movement data of the vehicle, data quality of the data portions, perspective of capture of the respective terrain part, age of the respective data or data portions, etc.

Remaining buffer stored data can be deleted, for example when moving away from the current vehicle position (maneuvering point). The first data can be established from data of perceptive sensors: a camera, an infrared camera, a TOF (time-of-flight) sensor system, a laser scanner, an ultrasound sensor system, a radar sensor system.

A2. The method according to aspect A1, also comprising assigning the first data, which were established at different times, to one another or to a position information item in the environment of the vehicle.

In this variant of the method, recording a continuous image sequence (video sequence) is not mandatory. It is also possible to select a plurality of individual images, for example, from one or more cameras and stitch these to one another and/or to certain coordinate points. As it were, a carpet of images arises, which is “rolled out” a few seconds later when driving on the first terrain part.

In the case of new or modified image regions, the newer image regions can be (selectively) adopted into the assigned data in each case.

A3. The method according to any one of the preceding aspects, wherein the position information item is an absolute and/or relative position of certain points of the first terrain part in the environment of the vehicle.

In particular, this can be a position information item relating to the following type of information item for one or more points of the terrain part: at least two distance information items or at least one distance information item and at least one angle information item.

Particularly preferably, establishing a multiplicity of the position information items and assigning these to a multiplicity of the data portions of the first data is effected in the process.

Particularly preferably, positions of the vehicle predicted for the near future are also taken into account. Consequently, it is possible to compensate the slightly delayed output of the presentation (which is due to technical constraints) on the display apparatus of the vehicle. Additionally, the section of the first data can be established depending on the predicted position data (e.g., for the next seconds).

A4. The method according to any one of the preceding aspects, wherein data for a second part of the presentation are produced in relation to a second terrain part which is not occupied by the vehicle, either currently or in the near future, and merging the first and second data, depending on the position of the vehicle in relation to the first terrain part and in relation to the second terrain part.

The data relating to the second part of the presentation can be the image of the environment outside of the region occupied by the vehicle made from data of at least two sensors, e.g., cameras. By way of example, these can correspond to the known top-view presentation; these need not be temporally delayed or buffer stored. These can (should be) reproduced in real time where possible or slightly adapted in time for adaptation to the determined time offset.

Here, suitable “temporal and spatial” merging is preferably carried out, at least of an image of the surroundings of the region occupied by the vehicle and a region not occupied by the vehicle.

A5. The method according to the preceding aspect, wherein one or more relative positions of the vehicle in relation to one or more assigned position information items are established depending on the data, in particular resultant data, of the movement of the vehicle.

Here, the relative positions can be established in particular by means of wheel sensors of the vehicle and/or an environment-capturing sensor system of the vehicle. In particular, the data relating to the resultant movement relate to the time interval between producing and outputting the first data.

A6. The method according to any one of the preceding aspects, wherein data relating to a second part of the presentation are produced, representing a second terrain part in the environment of the vehicle, which is not occupied by the vehicle, and merging the first and the second data, established depending on the position and/or movement, in particular on a relative movement of the textures or immovable objects in the first data and/or in the second data.

Here, the individual images can be recalled from the first data representing the first part of the environment depending on the times at which correspondence is determined in the position or movement of textures of the environment with the second data, representing the second part of the environment.

Here, such an offset, in particular a variable time offset, between the first data and the second data, in particular between the individual images of the first data, can be produced in such a way that, in the first part of the presentation and in the second part of the presentation, the relative movement of a stationary object or a stationary texture in the display is brought about in a manner fitting to one another.

Incidentally, in this variant of the method, the second data need not necessarily be displayed; these may also serve exclusively for orientation purposes and for a temporal assignment of the images from the first data.

A7. The method according to any one of the preceding aspects, wherein the display of the first part of the presentation or of the entire presentation is effected depending on the predetermined conditions which, in particular, are dependent on:
driving on an off-road path or an off-road region of the environment, occurring or being imminent, and/or
an effected or immediately imminent approach or crossing of a terrain curvature which exceeds a predetermined measure, and/or
the identification of vertical-dynamic influences on the vehicle, which exceed a predetermined measure or corresponds to a predetermined pattern.

Here, the first predetermined condition can be established depending on the data of a navigation system and/or the vehicle sensor system, in particular an inertial sensor system, a camera sensor system or a vertical-dynamic sensor system. An operating element can also be read.

The second predetermined condition can be established depending on the sensor-based capture of the terrain curvature.

In this invention, the two predetermined conditions are quite important as the production of such a display in many other use cases would be a rather bothersome, redundant information item, which moreover eats away the computational resources.

The terrain curvatures can be, for example, curbs, potholes, arching (also waves), immovable objects lying in the terrain, etc.

A8. The method according to any one of the preceding aspects, comprising the superimposition of one or more graphic elements, at least in the first part of the presentation, representing at least a current alignment and/or a predicted future tire position of the front wheels of the vehicle, in particular representing a trajectory of the vehicle established in advance.

An essential feature of the result: a presentation of data originating from the near past and graphics relating to the near future (e.g., a trajectory established in advance) are combined within a display and at the current time. This is preferably effected in such a way that the temporal and spatial conditions at a plurality of times in the near future result in minimal deviations from the then valid reality, in particular the spatial conditions.

A9. The method according to any one of the preceding aspects, comprising the superimposition of one or more graphic elements, at least in the first part of the presentation, representing at least a current alignment and/or a predicted future tire position of the rear wheels of the vehicle, in particular representing a trajectory of the rear wheels of the vehicle established in advance.

By way of example, here you are able to see the spatial relation of your rear tires, for example, in relation to the terrain artifact, e.g. a curb, AND how a predicted spatial relation will be at a certain steering wheel angle.

A10. A method for presenting a terrain region below a vehicle, wherein: data for a first part of the presentation are produced in relation to a first terrain part which will be under the vehicle in the near future; data for a second part of the presentation are produced, representing a second terrain part in the environment of the vehicle which is not occupied by the vehicle; and there is a combination of a presentation of a part of the data and a presentation of the second data on a display in such a way that the first terrain part and the second terrain region are presented with a predefined spatial relation at a plurality of times.

What follows is the description of an exemplary embodiment, which has exemplary features that are combinable with the further features described above:

Data for a first part of the presentation are produced in relation to a first terrain part which will be under the vehicle in the near future;

Data for a second part of the presentation are produced, representing a second terrain part in the environment of the vehicle which is not occupied by the vehicle;

If conditions determined in advance are satisfied, the following is carried out:

Merging the first and second data, depending on the geometric relation between the first terrain region and the second terrain part.

Here, outputting the first data can have a time offset, in particular a predefined time offset, in relation to outputting the second data.

The merging can be configured relating to the display times and/or to the geometric adaptation of the first part of the image and the second part of the image in relation to one another. To wit: the at least one image of the environment of the region occupied by the vehicle and of the region not occupied by the vehicle stand as a continuation of one another in the display, said regions, in particular, being able to be separated from one another by a separation element.

Merging may comprise an assignment of the image edges of the substantially adjoining first part of the presentation and of a second part of the presentation. This may also be configured in a manner similar to “stitching” of two individual photos when producing a panoramic image.

A combination of an image of the environment, representing a region of the environment occupied by the vehicle and a region of the environment outside of the region occupied by the vehicle is preferably output (displayed) within a presentation or display apparatus;

Further, the displayed presentation preferably comprises at least one graphic representing one or more dimensions of the vehicle, a symbolic contour of the vehicle as a line in this example. In particular, this graphic separates the parts of the display which represent the first terrain part and the second terrain part.

Alternatively, dimensions of the vehicle can be represented as a spatially appearing form, fitting to one or more forms of the vehicle.

Consequently, the driver can clearly distinguish which obstacles may go under the vehicle underbody and which may not.

What follows are examples of the conditions determined in advance:

Predetermined Conditions 1:

Means of the vehicle are used to establish that driving on an off-road path is occurring or imminent;

This can be established depending on the data of a navigation system and/or of the vehicle sensor system, in particular an inertial sensor system, a camera sensor system or a vertical-dynamic sensor system. An operating element may also be read.

Predetermined Condition 2:

Means of the vehicle are used to establish that driving over a terrain curvature exceeding a predetermined measure is imminent in the near future.

In this invention, the two predetermined conditions are quite important as the production of such a display in many other use cases would be a rather bothersome, redundant information item, which moreover eats away the computational resources.

Predetermined Condition 3:

Vertical-dynamic sensors and/or inertial sensors of the vehicle capture or recognize a comparatively strong influence, e.g., a significantly modified (uneven) action of force on at least one wheel of the vehicle and/or rolling or pitching of the vehicle.

Predetermined Condition 4:

Recognizing an operating action by the driver, in particular a control pattern, in which the assumption of an intended parking or maneuvering or turning maneuver, in particular, can be made.

Here, inter alia, the following advantages arise:
Orientation and assistance when parking and maneuvering;
Assistance when driving on off-road paths without complex upgrading of the suspension of the vehicle. Improvement of the subjective and subjective safety;
Rim protection, tire protection, underbody protection;
Output or provision of the images or image sequences can also be activatable or made available in an automatic fashion depending on the situation;
Reduction in the hardware resources required for the method.

### LIST OF REFERENCE SIGNS

1 Vehicle

2 Apparatus

3 Camera

4 Data of the environment

5 First region of the surroundings

6 Vehicle ground data

7 Periphery data

8 Edge data

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for establishing data representing an environment below a vehicle, the method comprising the acts of:
capturing surroundings data representing at least a part of the environment of the vehicle;
assigning position information items to the surroundings data;
determining a position parameter of the vehicle;
determining vehicle ground data from the surroundings data, wherein the position information items correspond to the position parameter of the vehicle such that the vehicle ground data represent a region of the environment of the vehicle above which the vehicle is currently situated; and
outputting the vehicle ground data on a display apparatus of the vehicle.

2. The method as claimed in claim 1, further comprising the acts of:
capturing a movement parameter representing a movement of the vehicle; and
determining surroundings data for a first region of the surroundings from the surroundings data, wherein the first region of the surroundings represents a portion from the environment of the vehicle which will be covered by the vehicle in the future with a predefined probability based on the movement parameter, wherein the vehicle ground data are at least partly determined from the surroundings data for a first region of the surroundings.

3. The method as claimed in claim 1, further comprising:
determining periphery data representing a portion of the environment that is currently not situated under the vehicle;
merging the periphery data and the vehicle ground data; and
outputting the merged periphery data and vehicle ground data on the display apparatus.

4. The method as claimed in claim 2, further comprising:
determining periphery data representing a portion of the environment that is currently not situated under the vehicle;
merging the periphery data and the vehicle ground data; and
outputting the merged periphery data and vehicle ground data on the display apparatus.

5. The method as claimed in claim 3, wherein merging the periphery data and the vehicle ground data comprises one or both of a temporal merging and a spatial merging, wherein the spatial merging comprises determining a geometric relation between the periphery data and the vehicle ground data and geometrically transforming the periphery data and/or the vehicle ground data based on a geometric relation.

6. The method as claimed in claim 3, wherein merging the periphery data and the vehicle ground data comprises recognizing and/or identifying and/or assigning one or both of textures and immovable objects in one or both of the periphery data and the vehicle ground data, and wherein the method further comprises homogenizing the periphery data and the vehicle ground data based on one or both of the textures and the immovable objects.

7. The method as claimed in claim 3, wherein a geometric transformation of images of the vehicle ground data and of the periphery data is adapted at least in a boundary region of the respective images of the vehicle ground data and the periphery data such that the boundary region of a display of the vehicle ground data and of a display of the periphery data represents a substantially transitionless representation of the textures of the surroundings.

8. The method as claimed in claim 6, wherein a geometric transformation of the images representing the vehicle ground data is adapted based on one or both of:
a perspective ratio with which another part of the display of the vehicle ground data is represented, and
an identified danger zone in relation to a part of the vehicle.

9. The method as claimed in claim 3, wherein a geometric transformation of the images of the vehicle ground data and of the images of the periphery data is adapted at least in a boundary region of the respective images of the vehicle ground data and the periphery data such that the boundary region of a display of the vehicle ground data and of the periphery data represents a transitionless representation of the textures of the surroundings.

10. The method as claimed in claim 3, further comprising:
producing, from the vehicle ground data, a part of the environment of the vehicle situated outside the part of the environment covered by the vehicle in a vicinity of a contour of the vehicle;
adapting geometric and/or perspective parameters of one or both of the vehicle ground data and the periphery data such that the textures of the vehicle ground data are displayed in a manner corresponding the textures of the periphery data.

11. The method as claimed in claim 4, further comprising:
producing, from the vehicle ground data, a part of the environment of the vehicle situated outside the part of the environment covered by the vehicle in a vicinity of a contour of the vehicle;
adapting geometric and/or perspective parameters of one or both of the vehicle ground data and the periphery data such that the textures of the vehicle ground data are displayed in a manner corresponding the textures of the periphery data.

12. The method as claimed in claim 3, wherein outputting the merged periphery data and vehicle ground data further comprises outputting at least one graphic representing dimensions of a contour of the vehicle on the display apparatus, wherein the graphic represents a boundary between parts of a display relating to the vehicle ground data and parts of a display relating to the periphery data.

13. The method as claimed in claim 1, further comprising outputting wheel information together with the vehicle ground data on the display apparatus.

14. The method as claimed in claim 1, wherein the vehicle ground data are displayed on a display apparatus if a predefined event occurs or is predicted for the near future, wherein the predefined event comprises driving on an uneven path, approaching an obstacle, or exceeding predefined vertical-dynamic influences.

15. The method as claimed in claim 3, wherein the vehicle ground data are displayed on a display apparatus if a predefined event occurs or is predicted for the near future, wherein the predefined event comprises driving on an uneven path, approaching an obstacle, or exceeding predefined vertical-dynamic influences.

16. The method as claimed in claim 1, wherein one or more of the vehicle ground data, the periphery data and the homogenized periphery data are provided wirelessly at a mobile user appliance and image content is generated on the mobile user appliance based on transmitted data.

17. The method as claimed in claim 2, wherein the position parameter and/or movement parameter is a resultant movement and/or a resultant position, respectively, of the vehicle over a plurality of successive movements of the vehicle.

18. The method as claimed in claim 1, wherein a combination of an environment image, representing a first part of the environment which is currently covered by the vehicle, and a second part of the environment which is currently outside of the part of the environment covered by the vehicle, is output on the display apparatus.

19. A computer program product comprising a non-transitory computer readable medium having stored thereon program code that, when executed, causes a processor of a vehicle to:
capture surroundings data representing at least a part of the environment of the vehicle;
assign position information items to the surroundings data;
determine a position parameter of the vehicle;
determine vehicle ground data from the surroundings data, wherein the position information items correspond to the position parameter of the vehicle such that the vehicle ground data represent a region of the environment of the vehicle above which the vehicle is currently situated; and
output the vehicle ground data on a display apparatus of the vehicle.

20. An apparatus for a vehicle for establishing vehicle ground data representing at least a terrain part below a vehicle, configured to:
capture surroundings data representing at least a part of the environment of the vehicle;
assign position information items to the surroundings data;
determine a position parameter of the vehicle;
determine vehicle ground data from the surroundings data, wherein the position information items correspond to the position parameter of the vehicle such that the vehicle ground data represent a region of the environment of the vehicle above which the vehicle is currently situated; and
output the vehicle ground data on a display apparatus of the vehicle.
